(19) United States
(12) Patent Application Publication
(10) Pub. No.: US 2013/0272125 A1
(43) Pub. Date: Oct. 17, 2013

(54) COMPONENT, SYSTEM AND METHOD FOR CONTROLLING COMMUNICATION OF DATA OF AT LEAST ONE APPLICATION OF A COMMUNICATIONS NETWORK

(71) Applicants: Javier Espina Perez, Eindhoven (NL); Daniel Martin Gorgen, Eindhoven (NL); MARC Aoun, Eindhoven (NL); Tim Corneel Wilhelmus Schenk, Eindhoven (NL); Oscar Garcia Morchon, Eindhoven (NL)

(72) Inventors: Javier Espina Perez, Eindhoven (NL); Daniel Martin Gorgen, Eindhoven (NL); MARC Aoun, Eindhoven (NL); Tim Corneel Wilhelmus Schenk, Eindhoven (NL); Oscar Garcia Morchon, Eindhoven (NL)

(73) Assignee: KONINKLIJKE PHILIPS N.V., EINDHOVEN (NL)

(21) Appl. No.: 13/996,605

(22) PCT Filed: Dec. 21, 2011
(86) PCT No.: PCT/IB2011/055837

§ 371 Date: Jun. 21, 2013

(30) Foreign Application Priority Data
Dec. 22, 2010 (EP) 10196411.2

(51) Int. Cl. H04L 12/70

(52) U.S. Cl. CPC H04L 47/10
USPC 370/230

(57) ABSTRACT

For improving application data traffic in a communications network, data traffic of at least one application of the communications network is divided into two types in view of the current situation of the network—a first type comprising data, which can be transmitted by delaying the transmission, and a second type comprising data, which should not be delayed but should be transmitted at the current time. When an analysis of the current (average) load of the network shows that transmitting both types of data could lead to a heavy data traffic, a temporal transmission suppression session can be performed with regard to at least one entity of the communications network. In the temporal transmission suppression session, transmitting of data of the first type is interrupted during transmitting data of the second type. After completion of transmitting data of the second type, transmitting data of the first type is resumed.

### FIELD OF THE INVENTION

The invention relates to controlling communication of data of at least one application of a communications network. Particularly, the invention relates to a component and method for controlling communication of data of at least one application of a communications network, to entities of the communications network comprising the component and to a system and communications network comprising the entity.

### BACKGROUND

Remote management of devices or systems, also referred to as telemanagement, is receiving increased interest in the world. Remote management or telemanagement can be utilized in a plurality of areas like building automation, monitoring applications, sensor and sensor-actuator systems, medical applications, automotive techniques, automation etc. and is well known. In following, the present invention will be discussed with regard to an outdoor lighting system as an example for a system, where the remote management or telemanagement can be employed. However, it has to be pointed out, that the present invention can be used also with regard to further appropriate applications.

Recently, the remote management or telemanagement of outdoor luminaires or outdoor lighting systems respectively has received an increased interest. Thus, for example, utilization of the telemanagement enables use of different dimming patterns, such as function of time, weather conditions and season, allowing more energy efficient use of outdoor lighting systems. By use of telemanagement in an outdoor lighting system, a remotely monitoring power usage and/or detecting, predicting luminaire failures, for example, can be realized, which allow determining the most suitable time for replacing luminaires, repairing luminaires and/or adjusting or controlling the operation of the luminaires.

Radio frequency (RF) telemanagement networks enable implementation of several simultaneous applications such as street light and parking meter management, road sign control, and environmental sensing, for example. The implementation of the several simultaneous applications, however, implicates that high amounts of data are transmitted through the network. This often leads to heavy data traffic in the network. Even if the network is used for one application only, it must simultaneously support traffic for several functions concerning the one application, e.g. sensor data collection, alarming, node configuration and programming, and node control. For several reasons (one of them being complexity limitation), these different kinds or types of traffic and applications are implemented as independent software- and/or hardware-components that are put together to build a system. In following, these components are referred to as application components. These application components are neither aware of each other's operation nor of the characteristics of the RF network (e.g. routing algorithms), which leads to suboptimal performance in terms of delivery delay and data loss.

Thus, there is still a need for a methodology, which improves handling of high amounts of data transmitted through the network such that the performance of the network is improved. It is still required to reduce data delivery delays and data loss, to provide a balanced load distribution in the whole network, to avoid overloads and congestions in the network, to enable a time- and space-efficient transmitting of data in the network, etc.

In telemanagement networks, data is transmitted from (luminaire or further device or system) nodes to a control center, adapted for controlling the (luminaire or further device or system) nodes, via collector or controller nodes, adapted for enabling and managing communications between the luminaire nodes and the control center, and from the control center to the (luminaire or further device or system) nodes via the collector or control nodes. In the present application, the terms “controller node” and “collector node” have the same meaning and refer to nodes adapted for enabling and managing communications between the luminaire nodes and the control center. According to the present invention, also a “standalone” operation can be implemented, where the control center is implemented as a part of the collector node, i.e. in this case the terms “controller node” and “collector node” have a more general definition and refer to nodes adapted for controlling the (luminaire or further device or system) nodes and managing or controlling communications from the nodes to the collector node and vice versa.

Handling the high amounts of data transmitted through the telemanagement network or communications network, respectively, is difficult due to large-scale installations of corresponding devices or systems like the luminaires, for example. In a lighting system, above 200 luminaires can be installed, for example. Thus, the telemanagement network or communications network, respectively, comprising the (luminaire or further device or system) nodes, the collector or controller nodes and the control center is a large-scale network. Scalability of such large-scale networks and of applications or processes performed in the large-scale networks is known as being problematic and limited and represents a challenging task. Thus, there is still a need for efficient, robust and scalability functionality supporting high amounts of data transmitted through the telemanagement network or communications network respectively, which further allows or at least supports self-configuration and/or self-healing of the communications network in high traffic situations.

The known solutions for implementing communications networks comprising the (luminaire or further device or system) nodes, collector or controller nodes and the control center can be divided in two groups: implementation of star networks and implementation of mesh networks.

FIG. 1 shows an exemplary star network, where every (luminaire) node 13 (N) is connected via a direct connection 14 to a controller or collector node 12 (DC), wherein “N” is an abbreviation for “node” and “DC” is an abbreviation for “data collector”. The controller or collector nodes 12 (DC) and the control center 10 are connected via a connection 11, which can be, for example, internet, cellular or further communication enabling network. The star networks typically require a rooftop placed high-power/high-sensitivity base station like the collector or controller nodes 12 (DC), which makes the solution cumbersome to deploy and expensive. Alternatively, the collector or controller nodes 12 (DC) can be placed at a lower location (e.g. in a luminaire with one of the nodes), what, however, severely limits the cell range, especially in areas with high-rise buildings. Hence, the number of (luminaire) nodes 13 (N) per controller node 12 (DC) in such a case will typically not extend far above 100. This means that many collector or controller nodes 12 (DC) are needed, which all require an internet uplink, typically via a third party network. Another disadvantage is that, if a controller or collector node 12 (DC) fails, all (luminaire) nodes 13 (N) connected to the controller or collector node 12 (DC) are no longer connected.

FIG. 2 shows an exemplary mesh network, which does not have the above-outlined disadvantages of the star network. Since, the present invention is directed to communications networks having the mesh network structure, a more detailed description of mesh networks is provided below, when the present invention is described in more detail. By use of the mesh network, according to the present invention, the disadvantages of the star network are overcome.

However, also when the use of mesh networks allows avoiding the above-mentioned disadvantages of star networks, the problem of scalability still remains in the conventional mesh networks. Thus, appropriate methodologies are still required for enabling the scalability in the mesh networks.

US 2006/0187836 A1 discloses a communication device that enhances transfer of time-critical data between one or more Local Area Networks (LANs) and a device (e.g., edge router, etc.) coupled to a backbone network. A virtual bottleneck in the form of a queue is introduced by the communication device at the customer premises or customer end of a backbone network access line where the network congestion or bottleneck resides.

### SUMMARY OF THE INVENTION

In view of the above discussed disadvantages and problems, it is an object of the present invention to provide an improved controlling communication of data of at least one application of a communications network.

The object is achieved by the features of the independent claims.

The invention is based on the idea that in a communications network the data traffic, comprising data traffic of at least one application of the communications network, can be divided into two types—a first type corresponding to data, which, at a current situation of the network, can be transmitted by delaying the transmission, and a second type corresponding to data, which, in view of the current situation of the network, should not be delayed but should be transmitted at the current time. When an analysis of the current (average) load of the network shows that transmitting both types of data could lead to a heavy data traffic, a temporal transmission suppression session or temporal transmission interruption session, respectively, can be performed with regard to one entity, a set of entities of the communications network or with regard to the whole communications network, wherein the (luminaire or other device or system) nodes, the collector nodes and the control center correspond to the entities of the communications network. In the temporal transmission suppression session, initiated at at least one entity of the communications network, transmitting of data of the first type is interrupted during transmitting data of the second type. After completion of transmitting data of the second type, transmitting data of the first type is resumed. In this way, according to the present invention, in the entities, application components with awareness of each other are provided. Thus, data traffic of the first type and data traffic of the second type do not always flow independently of each other across the communications network. Further, scalability of the communications network is enabled.

In one aspect of the present invention, an application traffic controlling component is provided, which is configured to control communication of data of at least one application of a communications network at an entity of the communications network, wherein transmission of a first and a second type of data of the at least one application of the communications network is controlled, and wherein the application traffic controlling component is adapted to initiate a temporal transmission suppression session, where transmitting of a first type data, being data of the first type, is (temporarily) interrupted and a second data, being data of the second type, is transmitted while the temporal transmission suppression session. In this way, it is achieved that the application components, which communicate and handle the application data at entities and communication of which is controlled by the application traffic controlling component, become aware of each other, what in turn improves performance of the communications network. Further, due to more intelligence and awareness of data communicated, a better scalability of the communications network is enabled. Additionally, also more possibilities for self-healing and self-configuring are allowed in the communications network.

The at least one application of the communications network comprises at least one of the following: performing and/or supporting functions of the communications network (e.g. the above-mentioned street light and parking meter management, road sign control, environmental sensing etc.) and performing and/or supporting operating of the communications network (e.g. alarming, entity (e.g. node, collector node) configuration and/or control etc.). Further, it has to be mentioned, that after ending the temporal transmission suppression session, the transmitting of the first type data is resumed (by the corresponding components/entity), i.e. the first type data is transmitted after interrupting.

According to an embodiment of the present invention, the entity is a node of the communications network, a collector node of the communications network or a control center of the communications network. Thus, the present invention can be implemented at every general node of the communications network, what supports the scalability of the communications network at several levels of the network (in dependence of amount of connections of the corresponding entity and its functions, for example). For example, the more connections an entity has and/or the more control functionality the entity has the more further entities will be addressable by the application traffic controlling component and its temporal transmission suppression session and vice versa.

According to an embodiment of the present invention, the first type corresponds to data to be transmitted from a control center of the communications network to at least one node of the communications network, the second type corresponds to data to be transmitted from the at least one node of the communications network to the control center; and/or the first type corresponds to data, delay of transmission of which is admissible in the communications network, the second type corresponds to data, delay of transmission of which is critical in the communications network. Thus, a flexible handling and categorizing of data is possible, what in turn leads to a flexible handling with regard to a present situation in the network, wherein it can be flexibly decided, transmission of which data should be interrupted or held back and transmission of which data should be performed at the current time during the interrupting. The first type of data may refer, for example, to delay-uncritical data and the second type of data may refer, for example, to delay-critical data. The delay-critical data may comprise, for example, alarm messages from the nodes and/or the control nodes informing about a change in the communications system, which can be critical for operating of the communications system, (interactive) configuration messages from the control center etc., i.e. data, which has to be delivered in the communications network urgently and transmission delay of which can cause failures, interferences or further damages in the communications network. The delay-uncritical traffic may correspond, for example, to report data or further application data, which has not to be delivered urgently and transmission delay of which will not cause failures, interferences or further damages.

According to an embodiment of the present invention, the application traffic controlling component is connected to at least one application component of the entity to control the communication of data of the at least one application of the communications network at the entity, the at least one application component being configured to perform operations related to the at least one application of the communications network. Thus, the application traffic controlling component has a direct contact and access to the application data of the communications network, said data being provided by the application components, and a possibility of fast deciding on transmitting of the data in dependence of the current situation in the network, e.g. a high load situation.

According to an embodiment of the present invention, the application traffic controlling component is adapted to: receive from a configuration component of the entity, said configuration component being a component adapted to configure the entity, a request for the temporal transmission suppression session; and/or receive from a communications stack a first mode message indicating that the temporal transmission suppression session is started and a second mode message indicating an ending of the temporal transmission suppression session. The communications stack is configured to enable or provide communication between the application traffic controlling component and the communications network and is referred to also as a protocol stack. Generally, the communications stack or protocol stack respectively represents a set of protocols used in a communications network and represents a prescribed hierarchy of layers, wherein the protocols are grouped into a vertical stack by placing protocols of lowest layer at the bottom and protocols of higher layers on the top of the stack. Thus, an awareness of operation of the entity is supported at several components of the entity leading to a better performance of the entity due to the increased intelligence of the components.

According to an embodiment of the present invention, the application traffic controlling component is adapted to transmit to the configuration component a response to the request, wherein by the response the temporal transmission suppression session is granted by the application traffic controlling component. Also here, awareness of operation of the entity is supported at several components of the entity.

According to an embodiment of the present invention: if at least one specific application component of the entity is adapted to transmit the first type data, the application traffic controlling component is adapted to transmit an interrupt starting message to the at least one specific application component for (temporarily) interrupting transmitting the first type data by the at least one specific application component, and to transmit an interrupt ending message to the at least one specific applications component, for ending the (temporarily) interrupting; if the application traffic controlling component is adapted to transmit the first type data, after the initiating the temporal transmission suppression session, the application traffic controlling component is adapted to (temporarily) interrupt transmitting the first type data; and/or if the application traffic controlling component is adapted to receive data of at least one first entity of the communications network and to transmit the received data to at least one second entity in the communications network and if the received data to be transmitted comprises the first type data, the application traffic controlling component is adapted to (temporarily) interrupt transmitting the first type data, comprised in the received data to be transmitted. Thus, a further support of awareness of operation of at least one entity of the communications network is supported at several components of the at least one entity. In this way, a more coordinated and balanced handling of data in the communications network is enabled, what in turn leads to a considerable improvement of performance and scalability in the network.

According to an embodiment of the present invention: the at least one specific application component is configured to sample the first type data with a predetermined frequency and the application traffic controlling component is configured to decrease the predetermined frequency by transmitting the interrupt starting message and to reset the predetermined frequency by transmitting the interrupt ending message; and/or the application traffic controlling component is configured to initiate a compression of the first type data at the at least one specific application component by transmitting the interrupt starting message and to end the compression of the first type data at the at least one specific application component by transmitting the interrupt ending message. Thus, a flexible implementing of the temporal transmission suppression session is enabled, which additionally is coordinated with capabilities of the components of the corresponding entity.

According to an embodiment of the present invention, when (temporarily) interrupting of transmitting the first type data is performed by the application traffic controlling component, the application traffic controlling component is configured to buffer the first type data in a storage. After, ending the temporal transmission suppression session, the application traffic controlling component may be configured to perform a corresponding transmitting of the buffered data. Also here, a flexible implementing of the present invention is enabled.

According to an embodiment of the present invention, the application traffic controlling component is adapted to transmit at least one (temporal) interrupt instruction to at least one further entity of the communications network or to an application traffic controlling component of the at least one further entity for performing the (temporal) interrupting at the at least one further entity of the communications network. Thus, the situation dependent handling of transmitting data, i.e. executing of the temporal transmission suppression session is applicable also in a part of, area of, and/or the whole network, what leads to a good, situation based and scalable management of the communications network.

According to an embodiment of the present invention: if the entity is comprised in a fast path of the communications network, the at least one further entity, the at least one first entity and the at least one second entity is an entity comprised in the fast path; the at least one entity, the at least one first entity and the at least one second entity is an entity of a whole set of entities comprised in the communications network; the at least one entity, the at least one first entity and the at least one second entity is an entity of a predetermined sub-set of entities comprised in the communications network; or the at least one entity, the at least one first entity and the at least one second entity is an entity of a random sub-set of entities comprised in the communications network. The term “fast path” refers to a communications path in the communications network, which comprises at least two entities of the communications network with communications connection between them and which is established by the communications network (e.g. one of the entities of the communications network like the collector node or control center, for example) to perform fast transmissions between two entities of the communications network, which are the start and end entities of the communications path, for a certain or predetermined period of time. Thus, the fast path can be established for a limited period of time and can be seen as a temporal transmission or communication path in the communications network. Also here, a good, flexible, situation based, scalable and effective management of the communications network is enabled.

According to an embodiment of the present invention, in the temporal transmission suppression session, the transmitting the first type data is (temporarily) interrupted for a predetermined time period. Thus, it may be guaranteed that the first type data will be transmitted at least after the predetermined time period, which can be defined in general for several temporal transmission suppression sessions or in dependence of the current situation of the communications network for a corresponding session individually. Further, it can be guaranteed that the second type data will have at least a predetermined time period for an uninterrupted transmission. This leads to an improved performance of the communications network, wherein loss of data is avoided and effective and situation dependent transmission is enabled.

According to an embodiment of the present invention, the application traffic controlling component is adapted to determine the predetermined time period as a percentage of the communications network operation time. Thus, a more situation dependent and current performance considering implementation is enabled. Here, it has to be mentioned, that also further possibilities of determining the predetermined time period can be implemented according to the present invention.

According to an embodiment of the present invention, the predetermined time period corresponds to a lifetime of the fast path. Also in this way, a more situation dependent and current performance considering implementation is enabled.

According to an embodiment of the present invention, the application traffic controlling component is adapted to initiate the temporal transmission suppression session, if the application traffic controlling component has received a temporal transmission suppression session request from a number of neighboring entities of the entity, which is equal or greater that a predetermined number. In this way, it is ensured that the starting of the temporal transmission suppression session is actually desired, necessary and useful in the communications network and that no wrong decision, which could interfere the performance of the communications network, is taken.

According to an embodiment of the present invention, the application traffic controlling component comprises a list of the neighboring entities for deciding whether the number of the neighboring entities is equal or greater than the predetermined number. Also in this way, the risk for wrong decisions is reduced, wherein by focusing on the neighboring entities a further scalability possibility is enabled.

According to an embodiment of the present invention, in the list to each neighboring entity a trust level is assigned and wherein the application traffic component is adapted to: increase the trust level of a neighboring entity, if the temporal transmission suppression session request is valid; decrease the trust level of a neighboring entity, if the temporal transmission suppression session request is invalid; and initiate the temporal transmission suppression session, if a sum of trust levels of the number of the neighboring entities is higher than a predetermined threshold value. Here, a further reduction of the risk for wrong decisions is provided. A request is valid, if it is received from an entity authorized for the requests and if the request is actually based on the current situation of the communications network and the current situation (e.g. high load) is an appropriate cause for the request.

According to an embodiment of the present invention, the application traffic controlling component is adapted to decide on initiating the temporal transmission suppression session by analyzing a current load of first type data in the communications network and an expected load of second data to be transmitted.

In one aspect of the present invention, a method is provided for controlling communication of data of at least one application of a communications network at an entity of the communications network, wherein transmission of a first and a second type of data of the at least one application of the communications network is controlled, wherein the method comprises steps relating to corresponding operations of the above-outlined application traffic controlling component described in more detail below. Particularly, the method comprises initiating a temporal transmission suppression session, where transmitting of a first type data, being data of the first type, is (temporarily) interrupted and a second data, being data of the second type, is transmitted while the temporal transmission suppression session.

In one aspect of the present invention, an entity of a communications network is provided, which comprises the said node the above-outlined application traffic controlling component described in more detail below.

In one aspect of the present invention, a system is provided, which comprises said entity. According to an embodiment of the present invention, the system is a outdoor luminaire system or outdoor lighting system respectively.

In one aspect of the present invention, a communications network is provided, which comprises said entity. According to an embodiment of the present invention, the communications network is an outdoor luminaire communications network or outdoor lighting communications network respectively.

According to an embodiment of the present invention, the (luminaire or other entity, device or system) node has at least one of the following properties: the node is adapted to transmit messages, data or information, respectively, to one control center (via at least one collector node) and to receive messages, information or data, respectively, from the control center; the node has limited processing capabilities; the node is a stationary node; the node has a position, which is fixed and possibly known in the communications network; the node transmits messages, data or information, respectively of limited data rate. According to a further embodiment of the present invention, the communications network is a mesh network. According to another embodiment of the present embodiment, the communications network is a large-scale network. By use of the above outlined structure of the communications network and by implementing nodes of the communications network with said properties, a robust, efficient and scalable operating of the communications network and its nodes is enabled, particularly, a robust, efficient and scalable handling of alarm message storms and transmitting of data, information, messages.

Thus, the present invention provides an improved controlling communication of data in a communications network, which allows a well and flexible scalability of the communications network, which is robust, fast, effective and resource saving, which allows a fast and effective self-healing and self-configuration of the communications network due to improving the performance by the temporal transmission suppression session and which enables a handling of application data that is coordinated with conditions and states in the communications network. Further, the components of entities and/or entities or the communications network become more aware of each other's operation and/or of characteristics of the communications network such that the performance of the network can be improved and data loss and data delivery delays can be avoided. Thereby, handling of high amounts of data transmitted through the network is improved and a balanced load distribution in the whole network is provided, what in turn leads to avoiding overloads and congestions and enable a time- and space-efficient transmitting of data.

### BRIEF DESCRIPTION OF THE DRAWINGS

In the drawings:

FIG. 1 illustrates a communications network implemented as a star network;

FIG. 2 illustrates an exemplary communications network, with regard to which the present invention can be implemented;

FIG. 3 illustrates an arrangement of entities of a communications network according to an embodiment of the present invention;

FIG. 4 illustrates controlling communication of data of at least one application of a communications network according to an embodiment of the present invention;

FIG. 5 illustrates steps utilized for controlling communication of data of at least one application of a communications network according to an embodiment of the present invention;

FIG. 6a, 6b illustrate steps utilized for controlling communication of data of at least one application of a communications network according to an embodiment of the present invention;

FIG. 7 illustrates steps utilized for controlling communication of data of at least one application of a communications network according to an embodiment of the present invention;

FIG. 8 illustrates steps utilized for controlling communication of data of at least one application of a communications network according to an embodiment of the present invention;

FIG. 9a illustrates configuration of an application traffic controller according to an embodiment of the present invention; and

FIG. 9b illustrates steps utilized for controlling communication of data of at least one application of a communications network according to an embodiment of the present invention.

### DETAILED DESCRIPTION

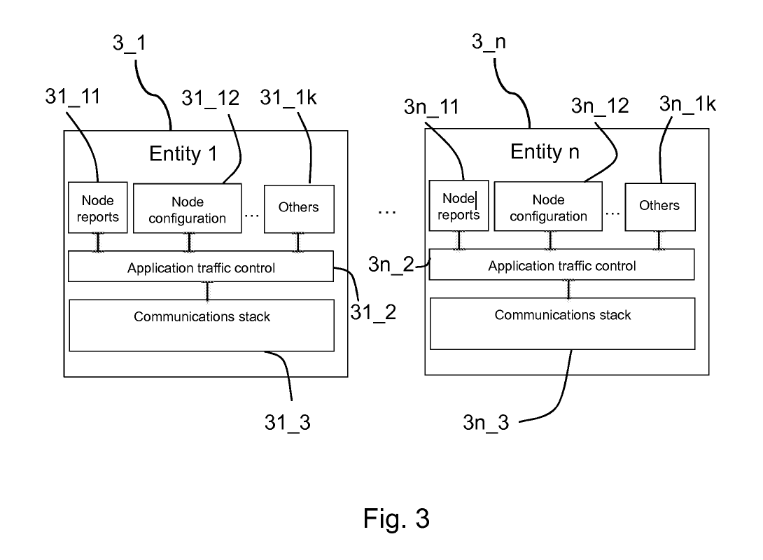

FIG. 2 illustrates an exemplary communications network, with regard to which the present invention can be implemented. According to the embodiment of FIG. 2, the communications network is a mesh network comprising a plurality of nodes 23 (N) and a plurality of collector nodes 22 (N/DC), all of them connected to each other via wireless connections 24. Since the present invention is explained by use of the example of (outdoor) lighting systems, the nodes 23 (N) correspond the luminaire nodes in the lighting system. However, in following also the general term “node” instead of the term “luminaire node” is used to indicate that the present invention is applicable correspondingly also to further areas like building automation, monitoring applications, sensor and sensor-actuator systems, medical applications, automotive techniques, automation etc. and is not limited to (outdoor) lighting systems only. Thus the nodes 23 (N) may be also further devices, entities or system nodes. Among the nodes 23 (N) and the collector nodes 22 (N/DC), wireless connection paths can be provided, each of the paths comprising a plurality of wireless connections 24. The nodes 23 (N) are configured to transmit information or data to other nodes 23 (N), 22 (N/DC), wherein the collector nodes 22 (N/DC) represent a specific kind of nodes of the communications network—nodes, which are adapted to receive the information or data from nodes 23 (N) and to transmit this information to a control center 20, which can be a device or system being adapted to control the communications network. Thus, the collector nodes 22 (N/DC) may operate in the manner of gateways between the nodes 23 (N) and the control center (20), which receive, collect the data or information from the nodes 23 (N) and forward the corresponding data or information to the control center (20). Further, the communication can be performed also in the opposite way, where the control center (20) transmits data or information to the nodes 23 (N) via the collector nodes 22 (N/DC), preferably, for controlling the nodes 23 (N). The transmitting of data or information between the nodes 23 (N) and the collector nodes 22 (N/DC) can be performed, for example, via single-hop or multi-hop transmissions. The transmitting of data or information between the control center (20) and the collector nodes 22 (N/DC) can be performed, for example, via a connection 21. The connection 21 can be, for example, a connection via an internet, mobile communications or cellular network, a radio system or other wired or wireless data transmission system. The wireless communication among the nodes 23 (N) and the collector nodes 22 (N/DC) can be constituted, for example, by RF transmissions via the wireless connections 24 or the wireless paths, respectively.

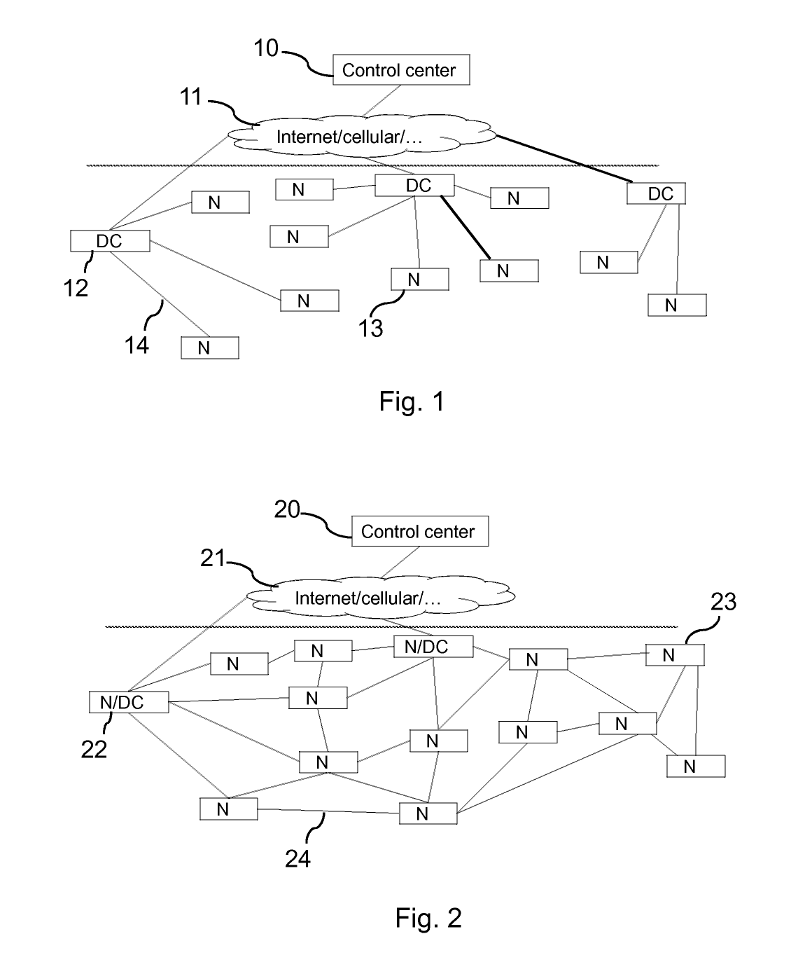

In comparison to the star network shown exemplary in FIG. 1, the present mesh network does not rely on direct communication between each of the collector nodes 22 (N/DC) and the corresponding nodes 23 (N) associated to the corresponding collector node 22 (N/DC). The communication is performed by forwarding or transmitting information or data between the nodes 23 (N) and the collector nodes 22 (N/DC) via multi-hop communications. This means that the collector nodes 22 (N/DC) can be installed flexibly with the nodes 23 (N). Further, the communications network, with regard to which the present invention is implemented, as shown exemplary in FIG. 2, meets also robustness requirements, since, if one of the collector nodes 22 (N/DC) fails, i.e., cannot perform its functions properly, the corresponding information, data or messages respectively can be routed to at least one another collector node 22 (N/DC) in the communications network. The same applies also to nodes 23. Thus, the communications network, with regard to which the present invention is implemented and which is shown exemplary in FIG. 2, has advantages with regard to deployment and robustness.

In general, mesh networks can be divided in two groups: a flooding-based mesh and a routing based mesh, explained shortly in more detail in the following.

The flooding-based mesh is a mesh network, in which all message are forwarded by all nodes in the network. The advantage of this technique is that it is extremely simple: a node does not have to decide to whom to forward a message, data or information, respectively, it just broadcasts it; and that the flooding-based mesh is robust due to the large number of messages, data or information respectively. The disadvantage of the flooding-based mesh appears in large networks (say typically >a few 100 nodes), since then the overhead due to forwarding of messages, data or information respectively starts impacting the overall data rate. This means that collisions of information, data or messages respectively start to appear, such that the overall performance may be reduced.

The routing-based mesh can be classified in general in two types: a routing-based mesh having a proactive scheme and a routing-based mesh having a reactive scheme. Proactive schemes keep all needed network paths up-to-date, e.g., by transmitting regular beacon messages to neighbors to discover efficient routing paths. To store the communications paths, every of the nodes (corresponding to nodes 23 (N) and collector nodes 22 (N/DC) of FIG. 2) may utilize a routing table. The main advantage is the efficiency in data, information or message transmission. The main disadvantage is the scalability, since the proactive update of the routing table consumes a large part of network resources in large networks. Moreover, the large (or full) routing tables might be required in every node. Also, in the startup of the network, long time (and costly use of resources) is required to build up the routing tables. Reactive schemes avoid the permanent overhead and large routing tables by discovering routes on demand. They use flooding to discover communications paths and cache active routes on nodes (corresponding to nodes 23 (N) and collector nodes 22 (N/DC) of FIG. 2). The advantage is an efficient performing of the communication. However, if routes are long, reactive schemes degenerate to proactive schemes with all of the advantages and disadvantages of the proactive schemes.

Thus, the main problem of the current types of mesh networks as outlined above with regard to the flooding-based mesh and the routing based mesh is the scalability.

According to the present embodiment, a communications network is utilized, which combines the positive properties of flooding- and routing-based mesh solutions, while achieving the required level of scalability. Thus, by use of the communications network as implemented according to the present embodiment, the advantages of the flooding- and routing-based mesh solutions are achieved and the scalability problem is solved.

For this, according to the present embodiment, the communications network has at least one of the following properties:
The communications network utilizes a (very) asymmetric communication, i.e., most of the data, information or message traffic is generated by nodes 23 (N) reporting, for example, their state and power usage to the control center 20 via collector nodes 22 (N/DC). The traffic could be, for example, approximately several kbytes per Node 23 (N) per day. Thus, the traffic comprises a N-to-1 traffic, which can be realized by unicasts, for example. The traffic in the other direction from the control center 20 to nodes 23 (N) consists basically of control commands or control related data transmitted from the control center 20 via collector nodes 22 (N/DC) to the different nodes 23 (N). Thus, the traffic in the other direction comprises 1-to-1 and 1-to-N traffic, which can be realized in unicast, multicast or broadcast mode, for example.
The number of nodes 23 (N) is extremely high compared to known wireless mesh networks, which often have less than 200 nodes.
The nodes 23 (N) have limited processing capabilities. When considering a lighting system, for example, due to cost considerations, the processing and memory resources in the luminaire nodes will be limited.
The nodes 23 (N) are stationary, i.e., they are fixed in their position, immobile, motionless, static, or at rest. Thus, compared to other ad hoc mesh networks, the communications network utilized according to the present embodiment of the invention is quite stationary, i.e., the nodes 23 (N) do not move, unlike the nodes in common communications networks. Consequently, network changes will arise in the communications network mainly due to a changing environment, e.g., due to traffic. Further, all nodes may be connected to mains power.
Positions of nodes 23 (N) are known, i.e., knowledge about the physical positions of the nodes (e.g. GPS coordinates) is known and accessible in the system, which can be applied at application level.
The required data rate is limited. That means that the considered application usually will not require a high data rate. However, there could be some scenarios, where a low response time is needed with regard to some certain types of messages (e.g. switching lighting nodes of a section, where a traffic accident happened, to a full power level after the traffic accident).

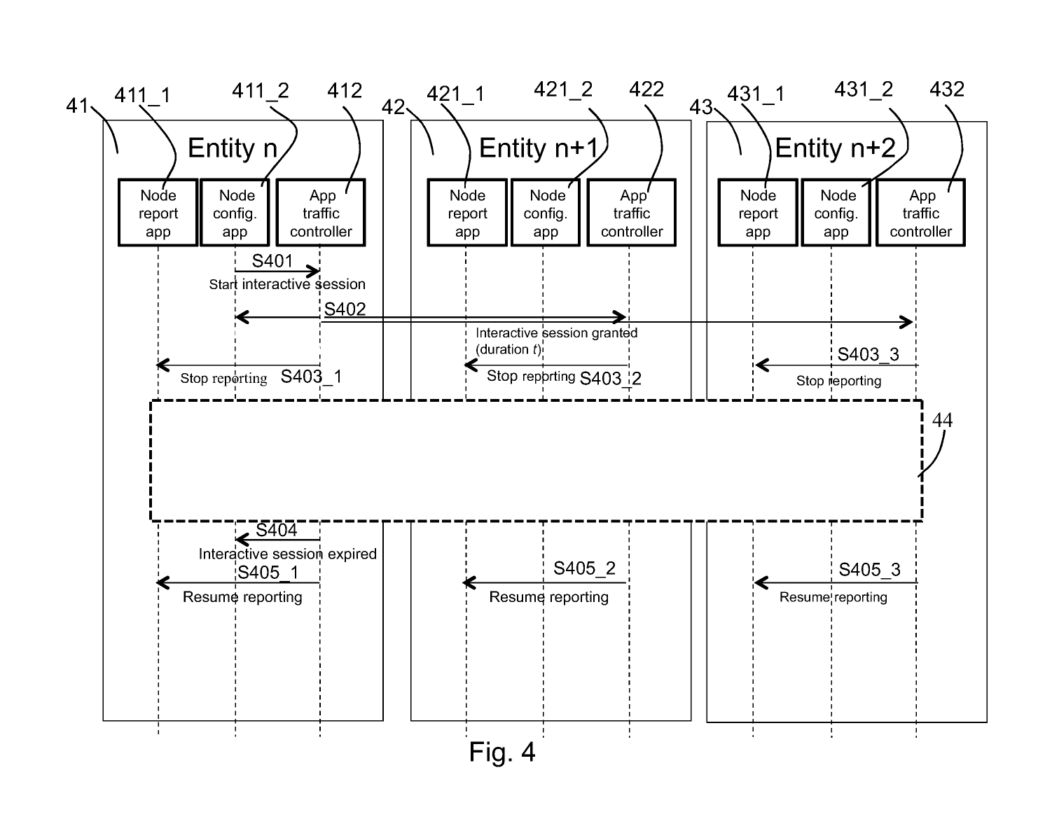

FIG. 3 illustrates an arrangement of n entities 3_1 to 3_n (Entity 1, . . . , Entity n) of a communications network, like the above-discussed network provided exemplary in FIG. 2, according to an embodiment of the present invention. An entity 3_1 to 3_n (Entity 1, . . . , Entity n) of the communications network may be a collector node 22, a (luminaire) node 23 or the control center 20. The “Application traffic controller” 31_2, 3n_2 of the present embodiment corresponds to the above-mentioned application traffic controlling component and enables the communication between application components 31_11 to 31_1k, 3n_11 to 3n lk. Application components may support applications of the communications network or parts of the applications, wherein the applications of the communications network may be, for example, node reporting, node configuration, data collection, alarming or functions of the communications network (e.g. street light and parking meter management, road sign control, environmental sensing etc.). In FIG. 3, for sake of a clear explanation of the present invention, only two more concrete applications or application components are indicated exemplary: “Node reports” 31_11, 3n_11 and “Node configuration” 31_12, 3n_12. The further applications are only sketched by boxes 31_1k, 3n_1k (Others) and can refer to every known appropriate application of a communications network. According to the present embodiment, the application components 31_11 to 31_1k, 3n_11 to 3n lk interface with the communications network via their local application traffic controller (ATC) 31_2, 3n_2. Further, according to the present embodiment the local application traffic controller (ATC) 31_2, 3n_2 is connected to a communications stack 31_3, 3n_3, which enables communications of the application components 31_11 to 31_1k, 3n_11 to 3n_1k with the communications network (i.e., transmitting and/or receiving of data, messages, information by the application components 31_11 to 31_1k, 3n_11 to 3n_1k) via the corresponding local application traffic controllers (ATC) 31_2, 3n_2.

As regards the application component “Node reports” 31_11, 3n_11, the report data traffic transmitted by said component is often not delay critical. However, according to the present embodiment, such traffic contains information (e.g. energy consumption) that is sent by all nodes 23 and collector nodes 22 and can therefore add up to large amounts of data. In addition, telemanagement networks must also allow for the timely delivery of delay-critical data—often less bulky than reporting data. Alarm traffic from the nodes 23 and collector nodes 22 and interactive configuration traffic from the control center 20 are two examples of such delay critical data. The potentially large amount of report data traffic can consume most of the communications network resources, especially in the proximity of data collectors 22 (or segment controllers), where all data flows to. When this occurs, delay-critical data traffic will be severely disrupted by report data traffic from the nodes 23 according to the present embodiment.

In following, the present invention will be described with regard to the above-outlined reporting as functions of an application of the communications network. However, it is pointed out, that said reporting represents just an example and that the present invention is not limited to this application or function of an application and can be applied also with regard to further applications and their functions.

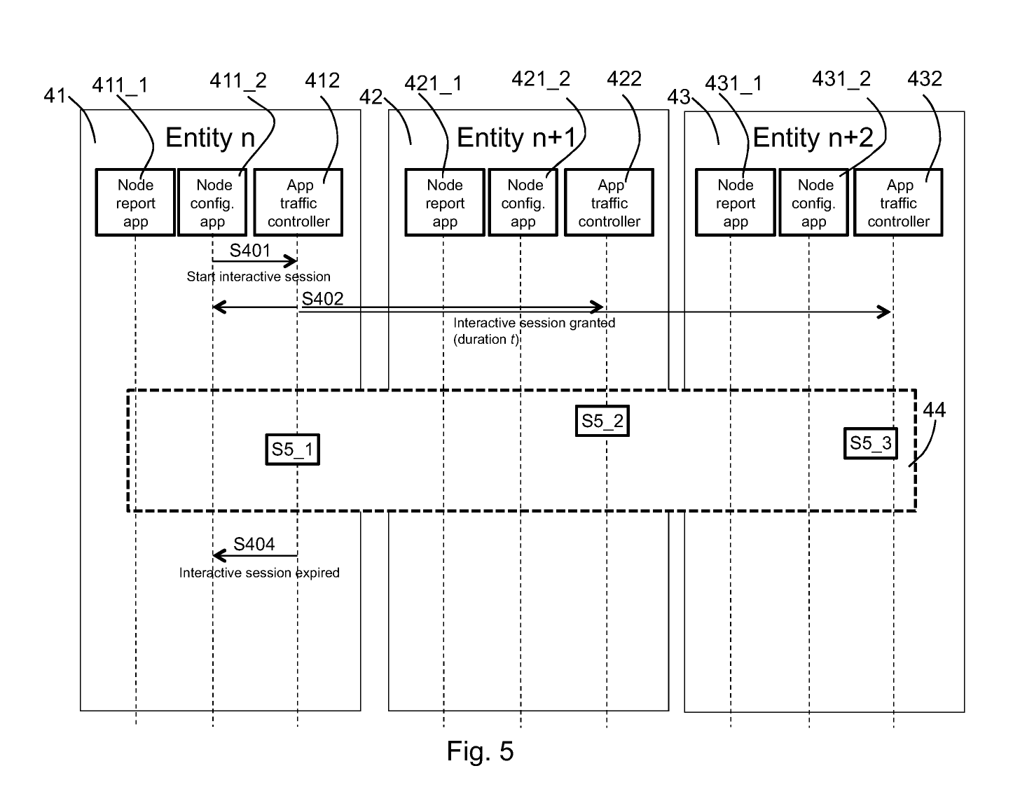

FIG. 4 illustrates controlling communication of data of at least one application of a communications network according to an embodiment of the present invention. According to the present embodiment three entities 41, 42, 43 (Entity n, Entity n+1, Entity n+2) are used exemplary. The n^{th} entity 41 may represent a control center 20, a data collector 22 or a node 23 of a radio frequency street lighting telemanagement network, for example. The n+1^{th} entity 42 and n+2^{th} entity 43 may represent, for example, further nodes 20, 22, 23 of the communications network.

According to the present embodiment, the node configuration application component 411_2, hereinafter referred to also as NC, of n^{th} entity 41 (for example, the control center 20) starts a temporal transmission suppression session 44 with a set of nodes 42, 43 of the communications network. The temporal transmission suppression session can be performed within the scope of further appropriate sessions like the interactive configuration session defining a prioritization period for configuration applications 411_2, 421_2, 431_2 for performing the configuration of the respective entities 41, 42, 43, i.e. during the interactive configuration session the configuring the entities 41, 42, 43 are performed with a higher priority than other processes in the entities 41, 42, 43. During the temporal transmission suppression session 44 a user can send a series of time-critical configuration commands to the nodes 42, 43. With regard to this, the NC 411_2 of the of n^{th} entity 41 sends S401 a request to its local application traffic controller 412, hereinafter referred to also as ATC, to start a temporal transmission suppression session 44, during which node reporting, operated by node reporting applications 411_1, 421_1, 431_1, should be suppressed, since according to the present embodiment, the node reports are seen as delay uncritical data from the nodes 41, 42, 43. Thus, according to the present embodiment the first type data, transmission of which is interrupted, refers to the more delay uncritical data of the node reporting 411_1, 421_1, 431_1 and the second data, transmission of which is performed at the current time, refers to the configuration commands transmitted to the entity 41 (e.g., a control center 20) by the user and interpreted as time- or delay-critical data.

After that, the ATC 412 of the of n^{th} entity 41 communicates 5402 the positive result of the request a transmission suppression session 44 grant—to the requesting NC 411_2 of the of n^{th} entity 41 as well as to the ATCs 422, 423 of all affected entities 42, 43 of FIG. 4. According to the present embodiment the transmission suppression session grant message transmitted in step S402 comprises a predetermined time period t, for which the transmission suppression session 44 is granted by the ATC 412 of the of n^{th} entity 41.

Next, according to the present embodiment, all ATCs 412, 422, 432 instruct S403_1, S403_2, S403_3 their local entity NR components 411_1, 421_1, 431_1 to suppress or interrupt respectively the periodical transmission of reports by a corresponding message for stopping or interrupting reporting. After the predetermined time period t, the suppression or interrupting respectively of the reporting traffic becomes inactive. Therefore, the ATC 412 of the of n^{th} entity 41 informs S404 its local NC component 411_2 about the expiration of the transmission suppression session 44 the latter had requested by a corresponding message indicating the expiration of the transmission suppression session 44 and, (immediately) after that, all ATCs 412, 422, 423 reactivate S405_1, S405_2, S405_3 the reporting traffic of their local NR components 411_1, 421_1, 431_1 by corresponding messages for resuming reporting.

The temporary suppression of report data for enabling an undisturbed transmission suppression session 44 may be started on explicit request by the user, just before manually submitting a series of configuration commands. Yet it may be responsibility of the control center software to decide to start the temporary suppression of report data. For making this decision it may consider, for instance, the amount and nature of the submitted configuration commands as well as the current load distribution in the network. Thus, in general, the corresponding entity 41, 42, 43 adapted to initiate the transmission suppression session 44 decides on initiating a temporal transmission suppression session 44 by analyzing the current load (distribution) in the communications network, particularly, by analyzing the load of data, transmission of which can be interrupted or suppressed respectively, and the probable, approximated or expected load of data, transmission of which should be performed now without interrupting or suppressing.

In general, according to the present embodiment, the delay-critical traffic transmission of which should be performed now without interrupting or suppressing is associated, for example, with sporadic events such as malfunction alarms, interactive control sessions, commissioning of the system, over-the-air software update, etc. These events may require a significant amount of bandwidth but usually during short periods of time in comparison with the (average) communications network operation time in general. However, according to the present embodiment, to prevent the starvation of report data traffic, its suppression due to delay critical traffic may only be allowed up to a certain limit. This upper limit may be defined as a percentage of the (average) network bandwidth (e.g. 20% or more or less), e.g. defined in available transmission time.

Depending on the average load of the communications network due to node reports and other traffic—it may be less or more necessary to suppress periodical reports during time-critical transactions. Therefore the temporary suppression or interrupting of report traffic does not need to affect the entire communications network. It can be performed with different communications network scopes or areas. At least the following three options can be identified with this regard.

Firstly, the temporary suppression or interrupting respectively can be applied with regard to all entities 20, 22, 23 of the communications network. Here, the whole communications network temporarily stops transmitting first type data of first type like the reports of the present embodiment to allow for time-critical traffic sessions.

Secondly, the temporary suppression or interrupting respectively can be applied with regard to a deterministic sub-set of entities 20, 22, 23 (e.g., a predetermined sub-set of entities 20, 22, 23). Here, a clearly identifiable part of the network (e.g. all entities 20, 22, 23 located in a certain physical area) temporarily stops transmitting the first type data of the first type like the reports of the present embodiment to allow for time-critical traffic sessions.

Thirdly, the temporary suppression or interrupting respectively can be applied with regard to a random sub-set of entities 20, 22, 23. Here, a random part of the network temporarily stops transmitting reports to allow for time-critical traffic sessions. This part may be defined by the group of entities 20, 22, 23 that choose to stop, interrupt or suppress transmitting the first type data (according to the present embodiment—the reporting). According to an embodiment, to this, to every entity 20, 22, 23 a probability P for suppressing or interrupting transmitting the first type data may be assigned, wherein the probability P (0≦P≦1) also means that the entity 20, 22, 23 transmits the first type data with the probability 1-P during such transmission suppression period. This will result, on average, that a part P of the entities will interrupt or suppress their transmission of the first type data.

In a further embodiment, such entities 20, 22, 23 could be chosen for the random sub-set, probability of which exceeds a predetermined probability threshold value. Thus, for example, it could be determined that all such entities, which have a probability P larger than X percent, for example, for suppressing or interrupting transmitting the first type data, could be chosen for performing the temporal transmission suppression session 44, X having a value larger than 0 and smaller than 100. According to a further embodiment, the random sub-set of entities 20, 22, 23 can be determined by choosing Y percent of entities 20, 22, 23 of the whole network or of such entities 20, 22, 23, that transmit the first type data and/or would suppress the first type data.

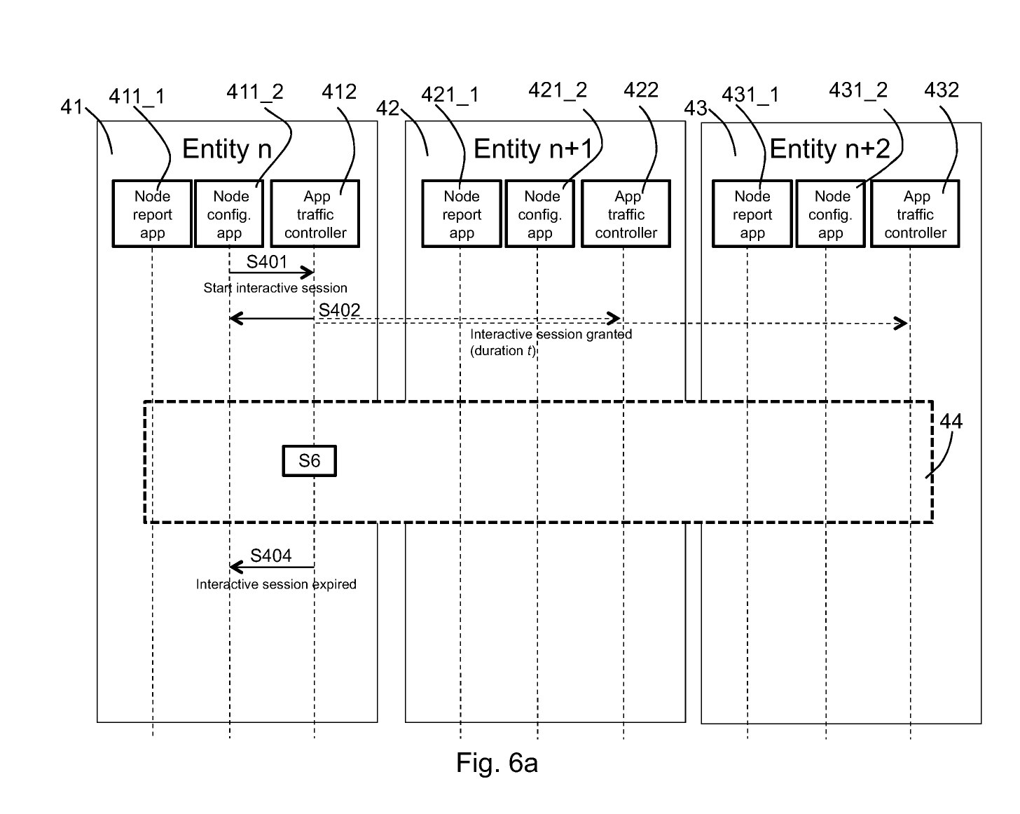

FIG. 5 illustrates steps utilized for controlling communication of data of at least one application of a communications network according to an embodiment of the present invention. The present embodiment of FIG. 5 refers to the embodiment shown in FIG. 4, wherein according to the present embodiment the steps S403_1, S403_2, S403_3 and S405_1, S405_2, S405_3 are not performed. Particularly, instead of communicating with their local NR components 411_1, 421_1, 431_1 to stop S403_1, S403_2, S403_3 and resume S405_1, S405_2, S405_3 report traffic generation, the ATCs 412, 422, 432 may directly filter and buffer the report data (first type data, transmission of which is interrupted or suppressed) during the transmission suppression session 44 in corresponding steps S5_1, S5_2, S5_3, thus becoming a sort of intelligent queue. This embodiment allows application component (here, NR component 411_1, 421_1, 431_1) implementations that are unaware of other application components (including the ATC 412, 422, 432). However it still enables synergy between application components via the ATCs.

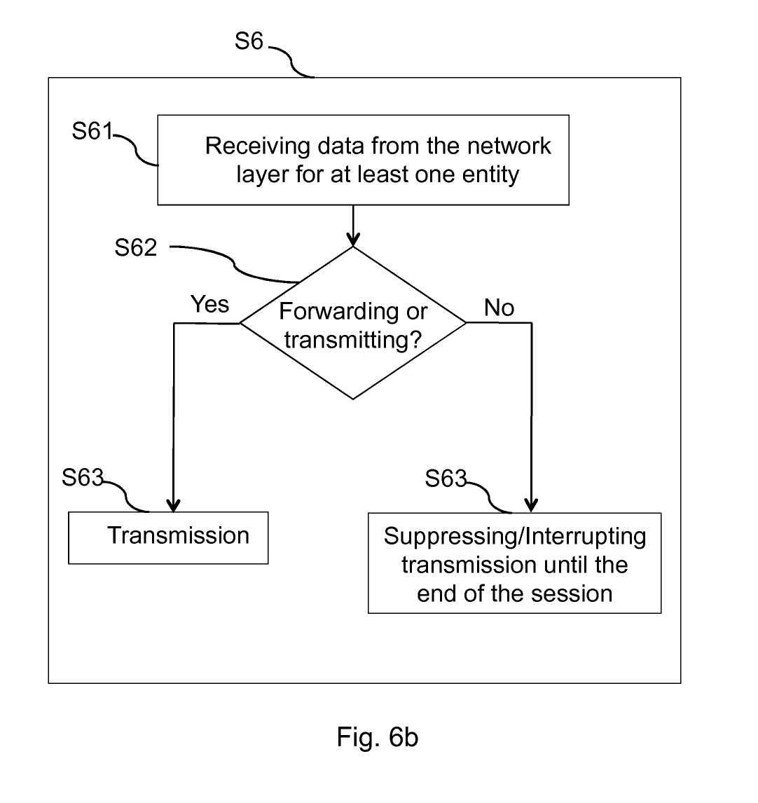

FIG. 6a illustrates steps utilized for controlling communication of data of at least one application of a communications network according to an embodiment of the present invention. The present embodiment of FIG. 6a refers to the embodiment shown in FIG. 5, wherein according to the present embodiment the steps S5_1, S5_2, S5_3 are replaced by performing step S6 of the present embodiment. Particularly, the suppression of report traffic (first type data traffic) described above with regard to FIG. 4 and FIG. 5 occurs always at the application layer. This means that an ATC 412, 422, 423 can only regulate the traffic of its local NR component 411_1, 421_1, 431_1. Nevertheless, according to the present embodiment, the ATC 412 of the transmission suppression session initiating entity 41 can also regulate the traffic from NR components 421_1, 431_1 of the further entities 42, 43, i.e., in general, from other application components of said entities 42, 43. To achieve that, the fact is used that in mesh networking, entities forward messages of other entities in the network. The, according to the present embodiment, in step S6, the networking layer of the entity (e.g. the communications stack) sends to the ATC 412 of the entity 41 all report messages (i.e. the first type data) that need to be forwarded on behalf of other entities 20, 22, 23 of the communications network. The ATC 412 makes thus in step S6 the decision whether a received report message should be forwarded and suppresses/interrupts the transmission/forwarding of the received report message. Here, in step S6, the ATC 412 may directly filter and buffer the report data (first type data, transmission of which is interrupted or suppressed) during the transmission suppression session 44, thus becoming a sort of intelligent queue for all NR components 411_1, 421_1, 431_1. In this way, parts of the communications network (for example a ring of devices around the collector) may be set to build a sort of a net that temporarily filters all reporting traffic (i.e. first type data) out. In the present embodiment, transmitting S420 a message, indicating that the transmission suppression session has been granted, from the ATC 412 to the further ATCs is rather optional and can be performed for the case that transmission of further data of further application components should also be done during the transmission suppression session 44 and that the ATC 412 does not receive the corresponding further data. In this case, steps S5_2, S5_3 would be performed at the ATCs 422, 432 for the further data. The resume operating messages would be sent from the ATCs 422, 432 to the corresponding further application components of the entities 42, 43 after the expiration of the transmission suppression session 44. Sub-steps of step S6 are illustrated in FIG. 6b. In the temporal transmission suppression session 44, the ATC 412 receives S61 from the network or network layer, respectively, data for entities 41, 42, 43 and decides S62 on forwarding or transmitting the data. If the data is second type data, the data is transmitted S63. If the data is first type data, the transmission of the data is suppressed or interrupted until the end of the temporal transmission suppression session 44, wherein, as outlined above, the data may be buffered during the session 44.

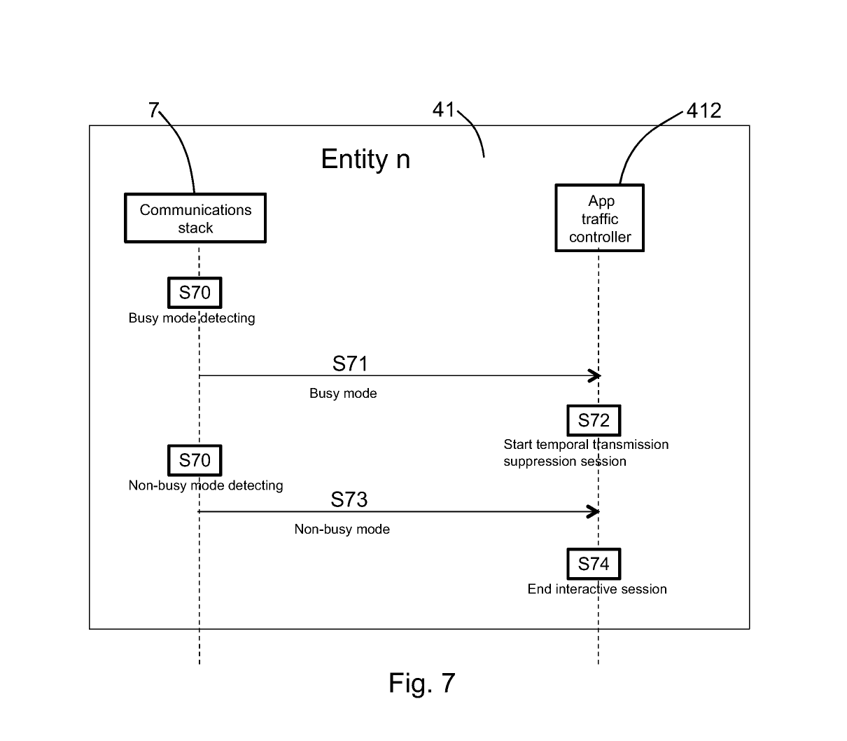

FIG. 7 illustrates steps utilized for controlling communication of data of at least one application of a communications network according to an embodiment of the present invention. The present embodiment of FIG. 7 is combinable with all embodiments of the present invention, wherein the above-mentioned steps of requesting S401 a start of a temporal transmission suppression session 44, transmitting S402 a grant from the ATC 412 to the NC 411_2 and transmitting S404 the message indicating expiration of the temporal transmission suppression session 44 are not required according to the present embodiment, which addresses a the communications stack of the entity n listening to the wireless medium. According to the present embodiment, the networking layer of such entity 41 comprises an interface to the ATC 412 of the entity 41, by use of which the communications stack 7 indicates two modes, wherein in a first mode the temporal transmission suppression session 44 is to be initiated and in a second mode the temporal transmission suppression session 44 is not required and, thus, can be ended. According to the present embodiment, the two modes are referred to as busy and non-busy mode. If a busy mode or period is detected S70 by the communications stack of the entity 41, the busy mode or period is signalized S71 from the communications stack 7 of the entity 41 to the ATC 412 of the entity 41 (via said interface) when the network layer forwards time critical messages, for example. In response to this, the ATC 412 initiates or starts S72 a temporal transmission suppression session 44. A non-busy mode or period is signalized S73 from the communications stack 7 to the ATC 412 of the entity 41 (via said interface) when the network layer does not observe any saturating traffic pattern, for example. In response to this, the ATC 412 ends or initiates ending S74 of the temporal transmission suppression session 44. Thus, in the present embodiment the communications stack 7 is adapted to sense S70, how busy the entity 41 is and/or how busy the communications network or the environment of the entity 41 in the communications network is, said environment comprising neighboring entities of entity 41 (at a predetermined radius, for example). To this, in step S70, the communications stack 7 can observe the traffic of the entity 41, of the communications network and/or of the environment. In step S70, the communications stack 7 can estimate, how busy the entity 41, the communications network and/or of the environment is, for example, by analyzing the number of passing packets, data, messages or information, respectively, in a time period. According to this embodiment, if the number is above a predetermined threshold, for example, a busy mode is detected or determined, otherwise a non-busy mode is detected or determined. Thus, the communications stack 7 determines whether the entity 41, the communications network or the environment of the entity 41 has to handle a high load situation and is busy or not. In dependence of the sensing results (e.g., high load—busy, low or average load—not busy) the busy or non-busy modes are then indicated S71, S72 by the communications stack 7 to the ATC 412. The mode detecting S70 can be performed continuously, periodically or in a further appropriate way.

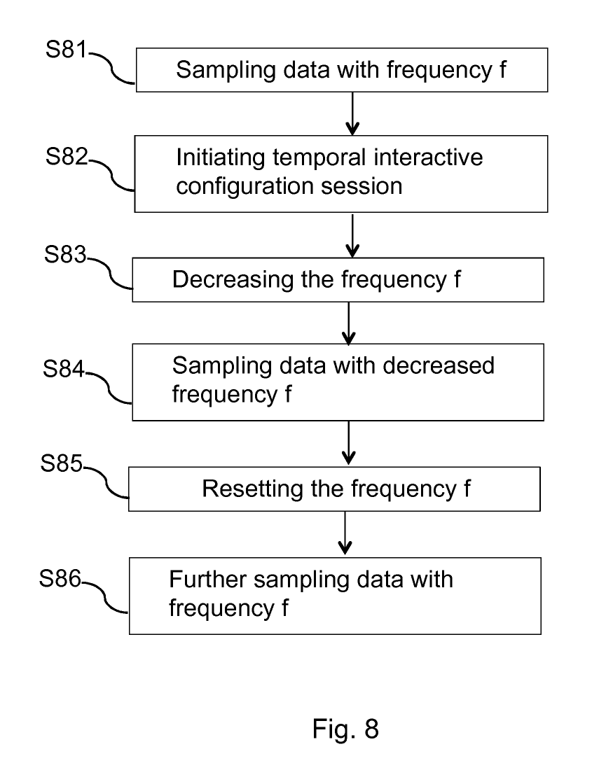

FIG. 8 illustrates steps utilized for controlling communication of data of at least one application of a communications network according to an embodiment of the present invention. Particularly, the steps of FIG. 8 can be combined with all embodiments of the present invention, where the suppressing or interrupting of transmitting the first type data like the report data, for example, is performed by application components like the NR 411_1, 421_1, 431_1, for example. Particularly, the present embodiment can be applied with regard to configurations, in which the application components like the NR 411_1, 421_1, 431_1 cannot communicate their reports for a long period of time, which can have severe consequences. For example, data might get lost due to lack of memory or storage. For sake of simpleness, it is assumed that a NR component 411_1, 421_1, 431_1 has to keep track of a given measurement as its application, wherein the present invention is not limited to this application only. To do this, the NR component 411_1, 421_1, 431_1 samples S81 the measurement values with a given frequency f. In order to safe memory while avoiding gaps of information or data, the frequency f can be configured according to the reporting rights. For example, if the NR component 411_1, 421_1, 431_1 is not allowed to report, it stores less information by sampling with a lower frequency f. Thus, when the temporal transmission suppression session 44 is initiated S82, the corresponding ATC 412, 422, 432 can, for example, indicate that the frequency f should be decreased. Here, the corresponding ATC 412, 422, 432 can, for example, indicate the degree, by which the frequency f should be decreased S83. The NR component 411_1, 421_1, 431_1 samples S84 then the data with the decreased frequency f. After expiration of the temporal transmission suppression session 44, the frequency f can be reset S85 to the previous (predetermined) value. The NR component 411_1, 421_1, 431_1 samples S86 then the data with the previous (predetermined) frequency f. Alternatively, instead of handling the frequency f, also other possibilities exist. Thus, for example, the such as the NR component 411_1, 421_1, 431_1 can use data compressing modules to compress the report data (i.e. the first type data).

According to a further embodiment, which is combinable with all embodiments of the present invention, the system or communications network may reserve a communication path to quickly route time-critical transmissions between two points of the network, e.g., alarm messages from the street of a car accident to a data collector. In this case, an entity 20, 22, 23, 41, 42, 43, 3_1 to 3_n transmitting a “stop reporting” message to the communications network (i.e. to the other entities 20, 22, 23, 41, 42, 43, 3_1 to 3_n of the communications network), via its local ATC 31_2 to 3n_2, 412, 422, 423, may create such a fast path by means of state-of-the-art reactive routing protocols. The path exists only for a limited period of time t. In this way, by use of the fast path, the number of entities 20, 22, 23, 41, 42, 43, 3_1 to 3_n affected by the temporary reporting suppression is limited to those entities 20, 22, 23, 41, 42, 43, 3_1 to 3_n along the fast path, which is used to transmit the delay critical messages, i.e. only those entities 20, 22, 23, 41, 42, 43, 3_1 to 3_n, which are comprised in the fast path, are involved for performing a corresponding temporal transmission suppression session 44, wherein according to a further embodiment, additionally, also entities 20, 22, 23, 41, 42, 43, 3_1 to 3_n, which are in a (predetermined) range of the entities 20, 22, 23, 41, 42, 43, 3_1 to 3_n comprised in the fast path can be involved in the session 44. Entities 20, 22, 23, 41, 42, 43, 3_1 to 3_n that are not in the fast path are allowed to transmit reports (i.e. the first type data). Even if the messages cannot reach the usual collector because it is blocked by the temporal fast path, the entities 20, 22, 23, 41, 42, 43, 3_1 to 3_n, which are not in the fast path, may continue reporting (i.e. transmitting the first type data); their ATCs 31_2 to 3n_2, 412, 422, 423 allow their network layers to know that, during the time period t (equal to the lifetime of the fast path), messages should be routed differently across the network (e.g. by transmitting them to another data collector than the usual one).

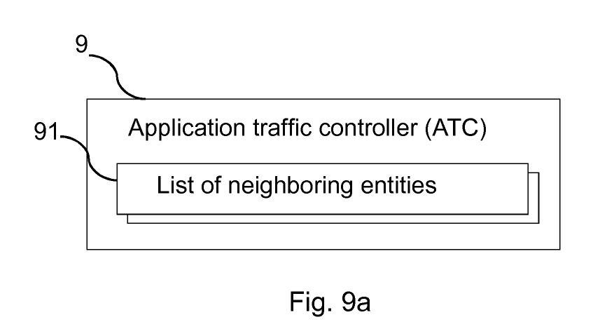

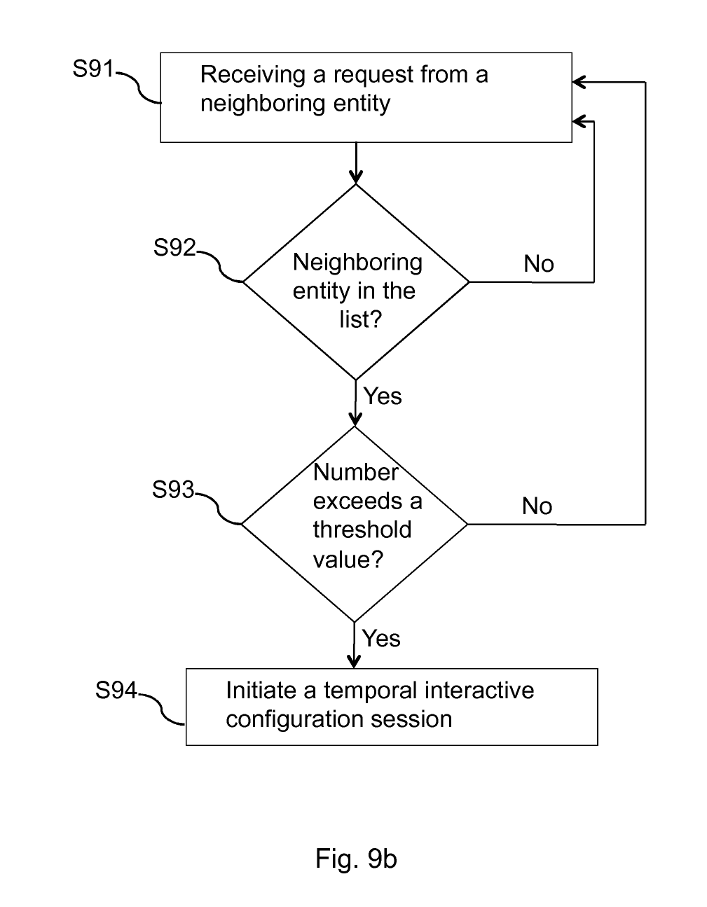

According to another embodiment as shown in FIGS. 9a and 9b, the temporal transmission suppression session 44 is initiated if at least a predetermined number of neighboring entities 20, 22, 23, 41, 42, 43, 3_1 to 3_n has transmitted a corresponding request. This embodiment is combinable with all embodiments of the present invention, wherein the steps S401, S402, S404 used for communication between ATCs 31_2 to 3n_2, 412, 422, 423 and the NCs 31_12 to 3n_12, 411_2, 421_2, 431_2 and the steps of FIG. 7 are replaced by the temporal transmission suppression session initiating according to the present embodiment. According to FIG. 9a, an ATC 9 comprises a list 91 of neighboring entities 20, 22, 23, 41, 42, 43, 3_1 to 3_n. When the ATC 9 receives S91 a request of a neighboring entity 20, 22, 23, 41, 42, 43, 3_1 to 3_n for initiating a temporal transmission suppression session 44, the ATC 9 checks S92 whether the neighboring entity is comprised listed in the list 91. If so, the ATC 9 checks S93 whether the number of neighboring entities 20, 22, 23, 41, 42, 43, 3_1 to 3_n, which transmitted the request for said initiation is equal or greater than a predetermined threshold Th. If so, the temporal transmission suppression session 44 is initiated according to the present invention as outlined above. Thus, the local ATC 9 orders stop, suppress or interrupt reporting (i.e. transmitting the first type data), if and only if more than Th neighbors request it.

With regard to the present embodiment, let us assume three exemplary situations: first, an alarm occurs and several entities decide to transmit it, before which they request the network to suppress reporting; second, an out-of-order entity triggers a false alarm and requests the network to suppress reporting; third, an attacker compromises an entity and starts sending “stop reporting” messages for initiating a temporary transmission suppression session. Obviously, the first use case should be enabled and allowed, but not the last two. By the present embodiment, according to which the list 91 is kept in the ATC 9—the local ATC 9 initiates the temporary transmission suppression session if and only if Th or more than Th neighbors request it.

According to a further embodiment of the present invention, which is based on the embodiment visualized in FIGS. 9a and 9b, each entry in the neighbor list 91 might be linked to a trust level Tr. The trust level Tr of an entity 20, 22, 23, 41, 42, 43, 3_1 to 3_n can be updated every time the ATC 9 receives a “stop reporting” message from that entity 20, 22, 23, 41, 42, 43, 3_1 to 3_n for initiating a temporal transmission suppression session 44. If the message results to be valid or legal (i.e. corresponds to an request actually wanted in the communications network with regard to the current situation), the trust level is increased, otherwise it is reduced. The trust level might be updated according to the following formula: Trn,t+1=x S+(1−x)·Trn,t, where Tr is the trust level at time t for node n, x is a memory factor, and S is 1 if the last “stop reporting” message was legal of valid. Otherwise, it is zero. In such a setting, the ATC 9 decides to initiate the temporary transmission suppression session if the added trust level of the voting entities 20, 22, 23, 41, 42, 43, 3_1 to 3_n is higher than a given threshold.

According to the description above, delay uncritical traffic from the entities (mainly report traffic) is suppressed in favor of delay critical traffic. However it is also possible to apply the present invention irrespectively of the traffic types. The control center 20 may use it, e.g., to regulate the direction of all data traffic within the network (from or towards the nodes 22 or collector nodes 23). Thus, the communications network may alternate periods of time of communication towards the entities with periods of time of communication from the entities. In this way, the scalability of the communications network is enhanced further by preventing collisions of data traffic that is uncoordinatedly fed into the communications network from different locations.

The temporary suppression of data traffic may have different degrees affecting all nodes or a subset of nodes—and be upper-limited to prevent unfairness between traffic types. As mentioned, the present invention can also be used in a wider scope to regulate the direction (to/from the nodes) of any traffic type, which improves the data delivery performance of the communications network.

Thus, according to the present invention, for improving application data traffic in a communications network, data traffic of at least one application of the communications network is divided into two types in view of the current situation of the network a first type comprising data, which can be transmitted by delaying the transmission, and a second type comprising data, which should not be delayed but should be transmitted at the current time. When an analysis of the current (average) load of the network shows that transmitting both types of data could lead to a heavy data traffic, a temporal transmission suppression session can be performed with regard to at least one entity of the communications network. In the temporal transmission suppression session, transmitting of data of the first type is interrupted during transmitting data of the second type. After completion of transmitting data of the second type, transmitting data of the first type is resumed.

It is obvious that the above-described embodiments can be combined in various ways. By means of the above described application data traffic controlling, a methodology of high scalability in a large-scale communications network is provided, which enables an efficient and effective self-healing and self-configuration in the communications network, particularly, of nodes and collector nodes in the communications network. Furthermore, the performance of the communications network is improved, wherein data loss and delivery delays are avoided and a balanced load distribution in the communications network is ensured.

1. An application traffic controlling component configured to control communication of data of at least one application of a communications network at an entity of the communications network, the application traffic controlling component is configured to:
control transmission of a first and a second type of data of the at least one application of the communications network, and
initiate a temporal transmission suppression session, where transmitting of a first type data, being data of the first type, is interrupted and a second data, being data of the second type, is transmitted during the temporal transmission suppression session,
initiate the temporal transmission suppression session if the application traffic controlling component has received a temporal transmission suppression session request from a plurality of neighboring entities, wherein the number of plurality of neighboring entities is equal to or greater than a predetermined number.

2. The application traffic controlling component according to claim 1, wherein:
the first type of data corresponds to data to be transmitted from a control center of the communications network to at least one node of the communications network, the second type of data corresponds to data to be transmitted from the at least one node of the communications network to the control center; and
the first type of data corresponds to data, delay of transmission of which is admissible in the communications network, the second type of data corresponds to data, delay of transmission of Which is critical in the communications network.

3. The application traffic controlling component according to claim 1, wherein the application traffic controlling component is adapted to:
receive from a configuration component of the entity, said configuration component being a component adapted to configure the entity, a request for the temporal transmission suppression session; and
receive from a communications stack a first mode message indicating that the temporal transmission suppression session is started and a second mode message indicating an ending of the temporal transmission suppression session.

4. The application traffic controlling component according to claim 3, wherein the application traffic controlling component is adapted to transmit to the configuration component a response to the request, wherein by the response the temporal transmission suppression session is granted by the application traffic controlling component.

5. The application traffic controlling component according to claim 1, wherein:
if at least one specific application component of the entity is adapted to transmit the first type data, the application traffic controlling component is adapted to transmit an interrupt starting message to the at least one specific application component for interrupting transmitting the first type data by the at least one specific application component, and to transmit an interrupt ending message to the at least one specific applications component, for ending the interrupting;
if the application traffic controlling component is adapted to transmit the first type data, after the initiating the temporal transmission suppression session, the application traffic controlling component is adapted to interrupt transmitting the first type data; and
if the application traffic controlling component is adapted to receive data of at least one first entity of the communications network and to transmit the received data to at least one second entity in the communications network and if the received data to be transmitted comprises the first type data, the application traffic controlling component is adapted to interrupt transmitting the first type data, comprised in the received data to be transmitted.

6. The application traffic controlling component according to claim 1, wherein the application traffic controlling component is adapted to transmit at least one interrupt instruction to at least one further entity of the communications network or to an application traffic controlling component of the at least one further entity for performing the interrupting at the at least one further entity of the communications network.

7. The application traffic controlling component according to claim 5, wherein:
if the entity is comprised in a fast path of the communications network, the at least one further entity, the at least one first entity and the at least one second entity is an entity comprised in the fast path;
the at least one entity, the at least one first entity and the at least one second entity is an entity of a whole set of entities comprised in the communications network;
the at least one entity, the at least one first entity and the at least one second entity is an entity of a predetermined sub-set of entities comprised in the communications network; or
the at least one entity, the at least one first entity and the at least one second entity is an entity of a random sub-set of entities comprised in the communications network.

8. (canceled)

9. The application traffic controlling component according to claim 1, wherein the application traffic controlling component comprises a list of the neighboring entities for deciding whether the number of the neighboring entities is equal or greater than the predetermined number.

10. The application traffic controlling component according to claim 9, wherein in the list to each neighboring entity a trust level is assigned and wherein the application traffic component is adapted to:
increase the trust level of a neighboring entity, if the temporal transmission suppression session request is valid;
decrease the trust level of a neighboring entity, if the temporal transmission suppression session request is invalid; and
initiate the temporal transmission suppression session, if a sum of trust levels of the number of the neighboring entities is higher than a predetermined threshold value.

11. The application traffic controlling component according to claim 1, wherein the application traffic controlling component is adapted to decide on initiating the temporal transmission suppression session by analyzing a current load of first type data in the communications network and an expected load of second data to be transmitted.

12. A method for controlling communication of data of at least one application of a communications network at an entity of the communications network, wherein transmission of a first and a second type of data of the at least one application of the communications network is controlled, and wherein the method comprises initiating a temporal transmission suppression session, where transmitting of a first type data, being data of the first type, is interrupted and a second data, being data of the second type, is transmitted during the temporal transmission suppression session, wherein the temporal transmission suppression session is initiated if a temporal transmission suppression session request is received from a plurality of neighboring entities, wherein the number of plurality of neighboring entities is equal to or greater than a predetermined number.

13. An entity of a communications network comprising an application traffic controlling component according to claim 1.

14. A system comprising at least one entity according to claim 13.

15. The system according to claim 14, wherein the system is an outdoor luminaire system.
